(19) United States
(12) Patent Application Publication
(10) Pub. No.: US 2004/0238053 A1
(43) Pub. Date: Dec. 2, 2004

(54) Electromagnetic double valve having a common coil

(75) Inventors: Gerrit Jan Baarda, Emmen (NL); Frank Van Prooijen, Emmen (NL)

Correspondence Address: Honeywell International, Inc., Patent Services Group, 101 Columbia Road, Morristown, NJ, 07962, US

(73) Assignee: Honeywell International, Inc.

(21) Appl. No.: 10/819,723

(22) Filed: Apr. 7, 2004

(30) Foreign Application Priority Data
Apr. 8, 2003 (DE) 103 16 098.1

(51) Int. Cl. F16K 11/14

(52) U.S. Cl. 137/869

(57) ABSTRACT

Disclosed is an electromagnetic double valve comprising an electromagnetic coil disposed in a valve housing and two valve bodies disposed in the valve housing and shiftable in their directions of polarity. The valve bodies comprise permanent magnets which are shifted by a magnetization of the coil such that the valve bodies either move away from a valve seat or towards the same, thereby opening and closing a valve opening disposed in the valve seat, respectively. The double valve can be used as a servo valve for controlling main valves.

### BACKGROUND

The invention relates to an electromagnetic double valve having a common coil.

Electromagnetic valves are, for example, used in control means for gas burners. Known control means for gas burners are provided with a main valve, a servo valve and a servo controller.

Frequently, however, control means for gas burners have to meet an elevated safety standard. According thereto, an elevated safety regarding the closing of the main valve and an interruption of the gas flow is requested. Such requirements of security are usually taken into account by a second main valve connected in series. With such a construction, it is requested that the gas flow is safely interrupted, also if there occurs a defect or failure of one of the main valves. However, in most cases, such control means do not permit a modulation of the pressure, or the modulation is extremely difficult or comes up to the respective requirements to an insufficient extent only.

On account of the two main valves connected in series, it is useful for the control thereof to provide two servo valves, as well.

### SUMMARY

In one example embodiment of the invention, a double valve meets the requested safety standards while being adapted for low-cost manufacturing.

According to one example embodiment of the invention, an electromagnetic double valve comprises an electromagnetic coil disposed in a valve housing and two valve bodies shiftably provided in the valve housing are suggested, said valve bodies having permanent magnets and being shiftable in the directions of polarity of the permanent magnets. By a magnetization of the coil, the valve bodies are shifted such that they either move away from or towards a valve seat, thereby opening or closing a valve opening located in the respective valve seat. Thus, advantageously, a double valve can be operated by means of one coil only.

Moreover, the double valve is formed such that the coil is arranged between the valve bodies including their permanent magnets and that the directions of polarity thereof are either both directed in parallel with the corresponding direction of polarity of the electromagnetic coil or are both directed so as to be opposed to the corresponding direction of polarity of the electromagnetic coil. Thus, the double valve can be formed in a symmetrical arrangement favorable for the manufacture.

The two valve bodies and the coil are disposed in one chamber, respectively, so that the double valve housing is made up of at least three chambers separated from each other by two inner valve seats. Besides, outer valve seats can be arranged, respectively, on the outer sides of the outer chambers in which the valve bodies are accommodated. Each of the valve seats includes openings having a specific cross-section, which can be closed by shifting the valve body onto the corresponding valve seat. Thus, each chamber including the matching valve body, the matching valve seats and the openings thereof is provided with a valve function.

In one implementation, a further opening having a specific cross section is provided, respectively, in the two chambers receiving the valve bodies. Thus, together with the matching valve seats, the openings thereof and the matching valve bodies, said chambers form a three-way valve, respectively. Thus, a double valve whose two three-way valves can be operated via one coil only is provided.

In connection with another example embodiment, when a pressure modulation is desired, a biasing means is provided in at least on double valve for pressing the valve body against the respective valve seat against the magnetization direction of the coil. Thus, a closing safety of the valve in the case of a magnetization failure is given, as well as the possibility to modulate the fluid flow through the valve against the resistance of the spring in accordance with a magnetization force of the coil.

In another implementation, biasing means is provided in both chambers. These can be provided with different biasing forces and biasing resistances, respectively, so that, accordingly, different modulations of the fluid flows in the valves are possible.

Example implementations of the double valve involve the coil and valve body being arranged on one axis or on parallel axes with respect to their shifting direction. It is, however, also conceivable to provide the coil so as to be bent and to arrange the permanent magnets on the axes corresponding to the bends of the coil.

In both cases, the coil can comprise a core strengthening the magnetic force of the coil, wherein the coil can optionally be formed to be straight or bent, and the core can also optionally be formed to be straight or bent. Thus, the geometric arrangement of the chambers can be favorably formed in accordance with the requirements regarding the inflow and outflow of the fluid. In this connection, it is absolutely conceivable that the angles between the axes of the coil and/or of the core and the corresponding angles between the axes of the valve body deviate from each other by several degrees without restricting the operability of the double valve. Likewise, the axes need not be located in one and the same plane, but can be somewhat displaced spatially.

The double valve constructed as described above can then be used as a servo valve for controlling main valves.

### BRIEF DESCRIPTION OF THE FIGURES

Example embodiments of the invention will be described on the basis of the enclosed schematic figures.

FIG. 1 shows a sectional view of a double valve according to an example embodiment.

FIG. 2 shows a sectional view of a double valve according to another example embodiment.

FIG. 3 shows a sectional view of a double valve according to another example embodiment.

FIG. 4 shows a sectional view of the double valve from FIG. 1 in its use as a servo valve for main valves connected in series, according to another example embodiment.

### DETAILED DESCRIPTION

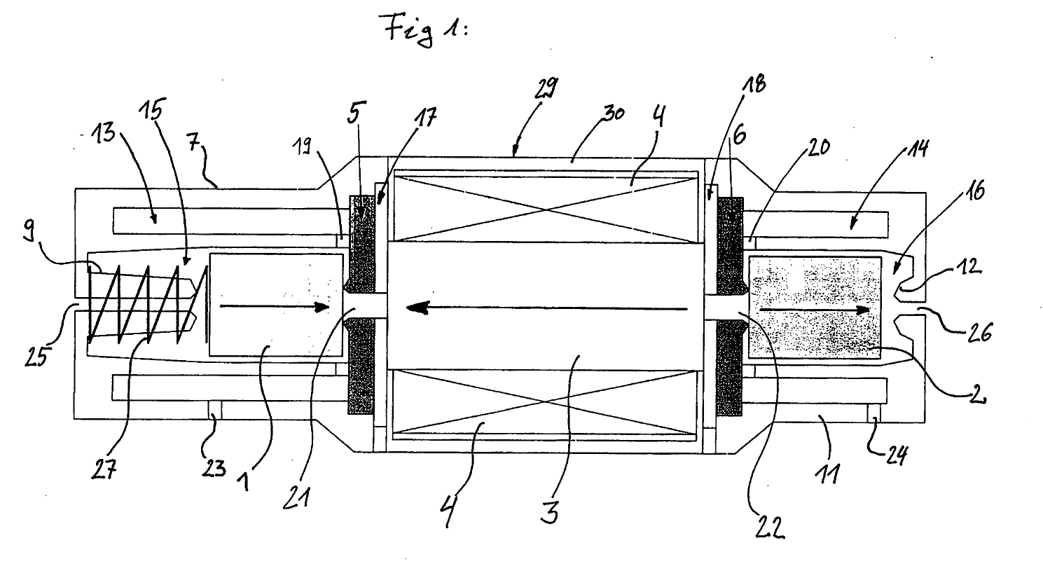

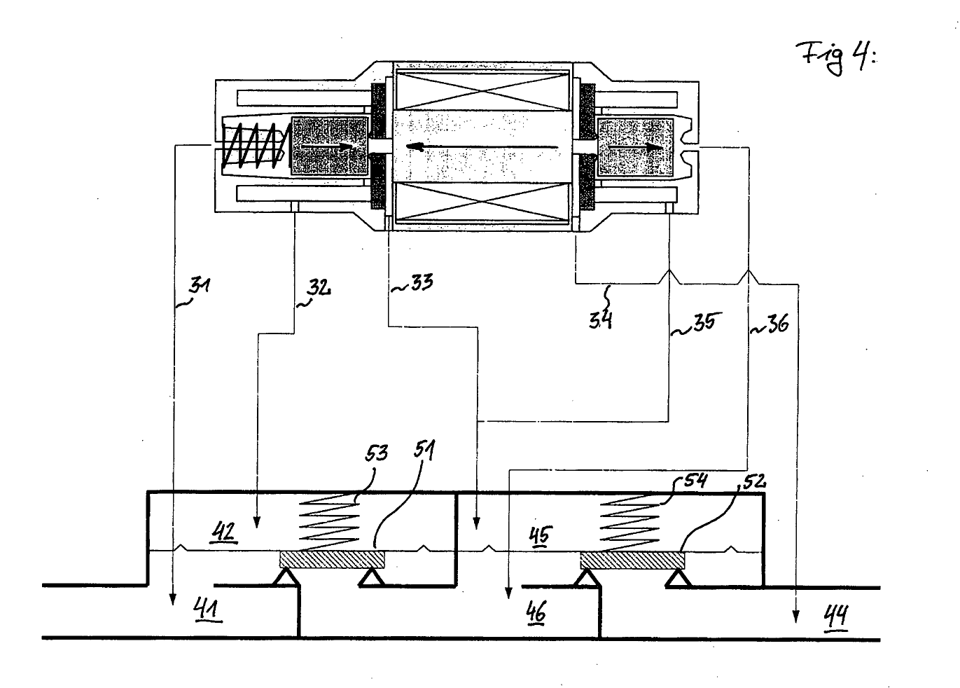

First of all, the construction of a double valve according to one or more various example embodiments is described on the basis of FIGS. 1 and 4. The double valve may be used as a servo-double valve for controlling two main valves. For discussion purposes, it is assumed that the fluid flows through the main valves from the left to the right.

The double valve is basically built up of a left valve section 7, a coil section 29 and a right valve section 11. The left valve section 7 is provided with an inner chamber 15 and an outer chamber 13 concentrically formed around the inner chamber 15. The outer chamber 13 communicates with the inner chamber 15 via openings 19 and, moreover, comprises an opening 23 to the outside, which serves as connection for a fluid line 32. The inner chamber accommodates a valve body 1 which, by a reciprocating movement, opens or closes either an outer opening 25 in an outer valve seat 9 or an inner opening 21 in an inner valve seat 5. The valve body 1 basically consists of a permanent magnet having a specific direction of polarity and being pressed against the inner valve seat 5 by means of a spring 27, so that it closes the opening 21.

When open, the opening 21 communicates the inner chamber 15 of the left valve housing with an intermediate chamber 17 which is located between the inner valve seat 5 of the left housing 7 and the coil body 3, 4 and which has an opening 8 as connection for a fluid line 33 to the outside. The coil body 3, 4 consists of a weakly magnetic core 3 and a coil 4 wound around the same.

A right valve housing 7 which is essentially symmetrical to the left valve section 7 is disposed on the right side of the coil section 29. The right valve housing 11 is also provided with an inner chamber 16 and an outer chamber 14 concentrically formed around the inner chamber 15. The outer chamber 14 communicates with the inner chamber 14 by means of openings 20 and comprises an opening 24 as connection for a fluid line 35 to the outside. The inner chamber 16 accommodates a valve body 2 which either opens or closes an outer opening 26 in an outer valve seat 12 or an inner opening 22 in an inner valve seat 6. The valve body 2 basically consists of a permanent magnet having a specific direction of polarity. A spring for biasing the valve body 2 against the inner valve seat 6 is, however, not provided in the right valve housing 11.

When open, the opening 22 communicates the inner chamber 16 of the right valve housing 11 with an intermediate chamber 18 which is located between the inner valve seat 6 of the right housing 11 and the coil section 29 and which has an opening 10 to be used as connection for a fluid line 34.

The coil section 29 disposed between the valve sections 7, 11 consists of a coil housing 30, a core 3 and a coil 4 wound around the core 3. The coil 4 is connected to an energy source (not shown) and is excited upon the supply of electrical energy such that it generates a magnetic force. The directions of polarity of the permanent magnets 1, 2 are selected such that there is a magnetically repellent force between the core 3 and the respective permanent magnet 1, 2, when the coil is excited, and that there is a magnetically attracting force when the coil is not excited. Thus, the permanent magnets 1, 2 are seated on the valve seats 5, 6 and close the openings 21, 22 when the coil 4 is in a non-excited state. Only when the coil 4 gets excited, are the permanent magnets pushed away from the valve seats 5, 6 and are the openings 21, 22 opened.

Thus, there are provided two double valves working as follows: when, in the non-excited state of the coil 4, the valve bodies 1, 2 are disposed on the inner valve seats 5, 6, thereby closing the openings 21, 22, the valves allow a through-flow from the opening 25 to the opening 23 and from the opening 22 to the opening 26, respectively. On the other hand, when the valve bodies 1, 2 are disposed on the outer valve seats 9, 12 thereby closing the openings 25, 16, the valves allow a through-flow from the openings 23 and 24 to the openings 21 and 22, respectively, and, thus, to the openings 8 and 10, respectively. The flow resistances can be adjusted as desired by designing the matching chambers and openings accordingly.

When the servo valves are closed, that is when the coil 4 is not excited, the core 3 disposed between the valve housings 7 and 77 attracts the two permanent magnets 1 and 2.

The openings 21 and 22 being thus closed, also the lines 33 and 34 which communicate with the openings 8 and 10, respectively, are closed. Since, however, the openings 25 and 26 are opened, a fluid communication from the inlet 41 of the main valve 51 via the line 31, the opening 25, the inner chamber 15, the openings 19, the outer chamber 13, the opening 23 and the line 32 to the chamber 42 of the main valve 51 is established, thereby keeping the main valve 51 closed by the force of the spring 53 because of the pressure balance produced in this way between the inlet 41 and the chamber 42.

Should, now, the main valve 52 fail for any reasons whatsoever and the fluid flow from the inlet 41 into the chamber 46, the pressure in the chamber 46 increases, whereupon fluid flows from the chamber 46 via the line 36 through the opening 26, the inner chamber 16, the openings 20, the outer chamber 14, the opening 24 and the line 35 into the chamber 45, thereby keeping the main valve 52 closed because of the pressure balance produced in this way between the chamber 46 and the chamber 45 and because of the additional resilient force of the spring 54. Because of the attracting force between the permanent magnet 2 and the coil core 3 and the flow direction of the fluid, the opening 22 in the valve seat 6 remains reliably closed. Thus, the safety aspect of the main valves 51, 52 connected in series is given, i.e. that at least one of the main valves 51, 52 is safely closed.

For opening the main valves 51, 52 and effecting a through-flow therethrough, the coil 4 of the servo-double valve is now excited with the aid of the energy source (not shown). When this is done, a magnetic force between the coil body 3, 4 and the permanent magnet 1, 2 is produced, said force first pressing the permanent magnet 2 off the valve seat 6 towards the valve seat 12. The opening 22 is being opened, and the opening 26 is being closed. Thus, via the line 34, the opening 10, the chamber 18, the opening 22, the inner chamber 16, the openings 20, the outer chamber 14, the opening 24 and the line 35, the fluid flowing off in the drain 44 generates a negative pressure in the chamber 45.

When the coil 4 gets more excited, the permanent magnet 1 is additionally pressed against the resistance of the spring 27 by a shifting amount corresponding to the ratio of the spring constant k of the spring 27 and the magnetization force, thereby opening the opening 21 without closing the opening 25 at the same time. That is to say the fluid flowing from the inlet 41 through the line 31 can flow through the line 32 into the chamber 42 as well as through the lines 33 and 35 via the valve housing 11 through the line 34 to the drain 44. The more fluid flows in the direction of the drain 44, the farther is the valve body 1 pressed away from the valve seat, that is the stronger is the magnetically repelling force of the coil 4 due to its electrical excitation. Since, in this state, the fluid flows from the opening 9 through the inner chamber 15 to the opening 21, a negative pressure acting on the chamber 42 of the main valve 51 via the line 32 is produced in the outer chamber 13. This cancels the pressure balance between the chamber 42 and the inlet 41, and a negative pressure is produced in the chamber 42. The valve 51 opens when the pressure difference between the chamber 41 and the chamber 42 is larger than the respective resistance of the spring 53, and its degree of opening can be modulated via the shifting amount of the valve body 1 which is controlled via the magnetization of the coil 4 and, thus, via the negative pressure in the outer chamber 13.

Fluid from the inlet 41 flows through the opened main valve 51 into the chamber 46 and increases the pressure in the chamber 46. Since, as described above, a negative pressure prevails in the chamber 45 and an overpressure acts in the chamber 46, the main valve 52 is now also opened, permitting a through-flow of the fluid through both main valves 51, 52.

Upon non-excitation of the coil 4, both main valves are again reliably closed, as has been described above.

Thus, by means of a double valve as a servo valve having only one coil, a dual main valve can be controlled, wherein, besides, the safety requirements regarding the closing of the main valves for interrupting the gas flow are taken into account.

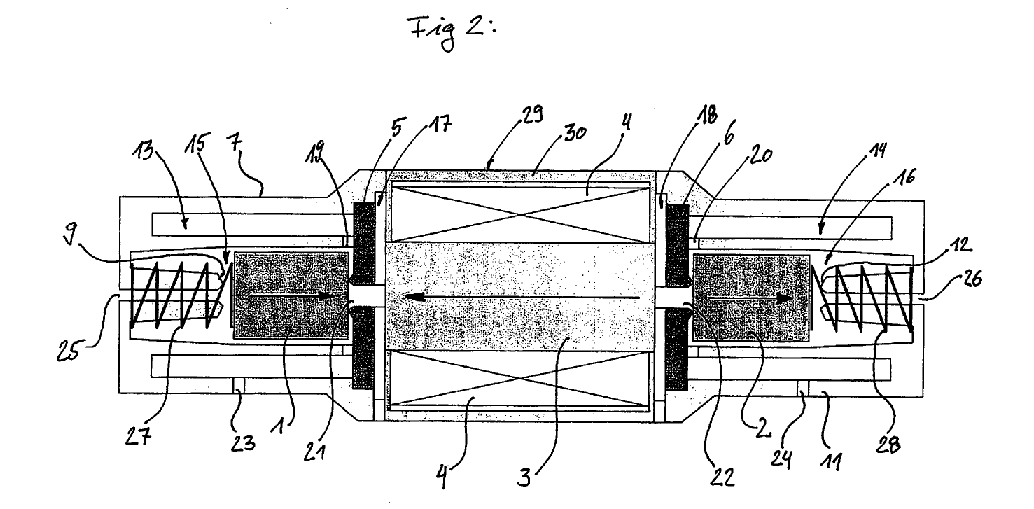

A second embodiment is shown in FIG. 2 and only differs in that, in the right valve housing 11, also a spring 28 is arranged between the valve body 2 and the valve seat 12 and, thus, also a modulation of the fluid flow from the opening 26 to the opening 24 and the opening 10, respectively, is possible. In this way, not only the first main valve 51, but also the second main valve 52 can be modulated.

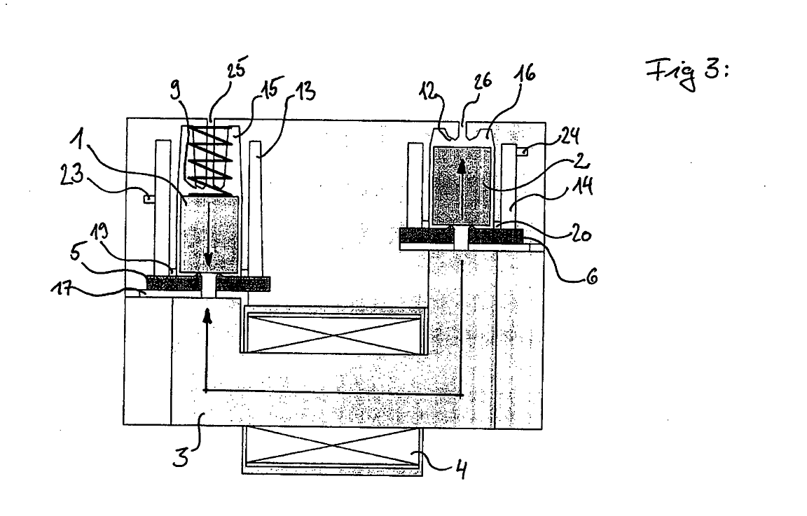

A third embodiment is shown in FIG. 3. This differs from the first embodiment in that the coil 4 comprises a U-shaped bent core, and the valve housings 7, 11 including their valve bodies 1, 2 are disposed on parallel axes aligned in accordance with the U-shape of the core. This offers advantages regarding the arrangement of the fluid lines from the servo valve to the main valves.

What is claimed is:

1. An electromagnetic double valve comprising:
a valve housing;
an electromagnetic coil disposed in the valve housing;
at least two valve seats;
two valve bodies in the valve housing, each valve body having a permanent magnet and being shiftable, in the valve housing, in a direction of polarity of the valve's permanent magnet as a function of a magnetization of the electromagnetic coil for opening and closing a valve opening disposed in a respective one of the valve seats.

2. An electromagnetic double valve according to claim 1, wherein the electromagnetic coil is adapted to generate magnetic force in a first direction when energized and to generate magnetic force in a second opposite direction when not energized, and wherein each valve body is respectively shiftable as a function of the direction of magnetic force generated by the electromagnetic coil.

3. An electromagnetic double valve according to claim 1, wherein each valve body is shiftable towards the electromagnetic coil in response to the electromagnetic coil being energized to an attracting magnetic state, relative to the valve body, and wherein each valve body is shiftable away from the electromagnetic coil in response to the electromagnetic coil being energized to a repelling magnetic state, relative to the valve body.

4. An electromagnetic double valve according to claim 1, wherein the permanent magnets have the same direction of polarity.

5. An electromagnetic double valve according to claim 4, wherein the permanent magnets have a direction of polarity that is at least one of: parallel with or opposed to the corresponding direction of polarity of the electromagnetic coil.

6. An electromagnetic double valve according to claim 1, wherein the at least two valve seats include at least one inner valve seat having an opening therein and disposed between the electromagnetic coil and one of the valve bodies.

7. An electromagnetic double valve according to claim 1, wherein the at least two valve seats include at least one outer valve seat having an opening therein and disposed on an outer opposite side of one of the valve bodies, relative to the electromagnetic coil.

8. An electromagnetic double valve according to claim 1, further comprising three chambers connected in series, divided by the at least two valve seats and in fluid communication via openings in the at least two valve seats.

9. An electromagnetic double valve according to claim 8, wherein at least one of the two valve bodies includes a respective one of the three chambers and three fluid openings at boundaries of the respective one of the three chambers, one of the fluid openings including an opening in the valve seat, the valve body being shiftable as a function of the magnetization of the electromagnetic coil to selectively couple two of the three openings.

10. An electromagnetic double valve according to claim 9, further comprising at least one biasing means for biasing one of the valve bodies against a respective one of the valve seats.

11. An electromagnetic double valve according to claim 1, further comprising at least one biasing means for biasing one of the valve bodies against a respective one of the valve seats.

12. An electromagnetic double valve according to claim 11, wherein, by magnetization of the electromagnetic coil to a first magnetization level, a non-biased one of the valve bodies is pressed away from its respective valve seat while the biased valve body remains against its respective valve seat and, by magnetization of the electromagnetic coil to a second magnetization level, the biased valve body is shifted against the biasing direction of the biasing means.

13. An electromagnetic double valve according to claim 11, further comprising another biasing means for biasing another one of the valve bodies against a respective one of the valve seats.

14. An electromagnetic double valve according to claim 13, each biasing means exhibits different biasing force.

15. An electromagnetic double valve according to claim 1, wherein the permanent magnets and the coil are arranged on a common axis.

16. An electromagnetic double valve according to claim 1, wherein the permanent magnets and the coil are arranged on parallel axes.

17. An electromagnetic double valve according to claim 1, wherein the coil is bent and wherein the permanent magnets and the coil are arranged on axes that form respective angles with each other.

18. An electromagnetic double valve according to claim 1, wherein the coil comprises a core.

19. An electromagnetic double valve according to claim 18, wherein the core is a bent core.

20. An electromagnetic double valve according to claim 19, wherein the permanent magnets and the coil are arranged on axes disposed with respect to each other at an angle corresponding to the bending of the core.

21. An electromagnetic double valve according to claim 1, wherein the electromagnetic coil is adapted for magnetization as a function of servo valve control characteristics for operating a main gas valve.
